(19) United States
(12) Patent Application Publication
(10) Pub. No.: US 2015/0332494 A1
(43) Pub. Date: Nov. 19, 2015

(54) PROVIDING AN IMAGE TOUR OF A POINT OF INTEREST

(71) Applicants: Yasutaka FURUKAWA, Bellevue, WA (US); Carlos Hernandez Esteban, Kirkland, WA (US); Steven Maxwell Seitz, Seattle, WA (US)

(72) Inventors: Yasutaka FURUKAWA, Bellevue, WA (US); Carlos Hernandez Esteban, Kirkland, WA (US); Steven Maxwell Seitz, Seattle, WA (US)

(73) Assignee: GOOGLE INC., Mountain View, CA (US)

(21) Appl. No.: 13/593,389

(22) Filed: Aug. 23, 2012

Related U.S. Application Data
(60) Provisional application No. 61/615,830, filed on Mar. 26, 2012.

(51) Int. Cl. G06T 15/00; G06K 9/46; G06T 7/00; G06T 19/00; G06T 17/00

(52) U.S. Cl. CPC G06T 15/005; G06T 19/003; G06T 17/00; G06T 7/0051; G06K 9/46

(57) ABSTRACT

Systems and methods for generating image tour are provided. Method includes receiving sequence of images. Each image has associated depth map and is characterized by plurality of parameters. Method includes interpolating flow path containing points corresponding to each image for each parameter. Each flow path relates parameterization to parameter. Method includes identifying rendering artifacts based on sequence of images, associated depth maps, and interpolated flow paths. Method includes identifying slow segments and fast segments in each of interpolated flow paths based on identified rendering artifacts. Method includes determining start/stop times for each of slow segments. Method includes interpolating time curve based on determined start/stop times for each of slow segments and fixed duration of time for each of fast segments. Time curve relates time to parameterization. Method includes providing sequence of images and values for each of plurality of parameters based on interpolated flow paths and time curve.

### CROSS-REFERENCE TO RELATED APPLICATION

The present application claims the benefit of priority under 35 U.S.C. §119 from U.S. Provisional Patent Application Ser. No. 61/615,830 entitled “PROVIDING AN IMAGE TOUR OF A POINT OF INTEREST,” filed on Mar. 26, 2012, the disclosure of which is hereby incorporated by reference in its entirety for all purposes.

The subject technology generally relates to visual data processing and, in particular, relates to providing an image tour of a point of interest.

### BACKGROUND

Given a sequence of images of a point of interest (e.g., the Statue of Liberty) with underlying depth maps or three-dimensional geometry, rendering techniques can be used to create an image tour that displays the images in the sequence while moving the camera from one image to the next. However, the resulting image tour may have several drawbacks. For example, the camera motion may not appear to be smooth or the rendering may include excessive artifacts. As the foregoing illustrates, a new approach for creating an image tour for a sequence of images of a point of interest may be desirable.

### SUMMARY

The disclosed subject matter relates to a computer-implemented method for generating an image tour. The method includes receiving a sequence of images. Each image in the sequence has an associated depth map and each image is characterized by a plurality of parameters. The method also includes interpolating a flow path containing points corresponding to each of the images for each of the plurality of parameters. Each flow path relates a parameterization variable to a parameter of the image. The method also includes identifying rendering artifacts based on the sequence of images, the associated depth maps, and the interpolated flow paths. The method also includes identifying slow segments and fast segments in each of the interpolated flow paths based on the identified rendering artifacts. The method also includes determining start and stop times for each of the slow segments. The method also includes interpolating a time curve based on the determined start and stop times for each of the slow segments and a fixed duration of time for each of the fast segments. The time curve relates a time to the parameterization variable. The method also includes providing the sequence of images and values for each of the plurality of parameters based on the interpolated flow paths and the interpolated time curve to a client device for rendering an image tour for display.

The disclosed subject matter further relates to a computer-readable medium. The computer-readable medium includes instructions that, when executed by a computer, cause the computer to implement a method for generating an image tour. The instructions include code for interpolating a flow path for each of a plurality of parameters. The flow path contains points corresponding to each image in a sequence of images. Each image in the sequence has an associated depth map and each image is characterized by the plurality of parameters. Each flow path relates a parameterization variable to a parameter of the image. The instructions also include code for identifying rendering artifacts based on the sequence of images, the associated depth maps, and the interpolated flow paths. The instructions also include code for identifying slow segments and fast segments in each of the interpolated flow paths based on the identified rendering artifacts. The instructions also include code for determining start and stop times for each of the slow segments. The instructions also include code for interpolating a time curve based on the determined start and stop times for each of the slow segments and a fixed duration of time for each of the fast segments. The time curve relates a time to the parameterization variable. The instructions also include code for providing the sequence of images and values for each of the plurality of parameters based on the interpolated flow paths and the interpolated time curve to a client device for rendering an image tour for display.

The disclosed subject matter further relates to a system. The system includes one or more processors. The system also includes a memory. The memory includes a data structure representing a sequence of images. Each image is characterized by a plurality of parameters. The memory also includes instructions which, when executed by the one or more processors, cause the one or more processors to implement a method for generating an image tour. The instructions include code for interpolating a flow path containing points corresponding to each of the images for each of the plurality of parameters. Each flow path relates a parameterization variable to a parameter of the image. The instructions also include code for identifying rendering artifacts based on the sequence of images, and the interpolated flow paths. The instructions also include code for identifying slow segments and fast segments in each of the interpolated flow paths based on the identified rendering artifacts. The instructions also include code for determining start and stop times for each of the slow segments. The instructions also include code for interpolating a time curve based on the determined start and stop times for each of the slow segments and a fixed duration of time for each of the fast segments. The time curve relates a time to the parameterization variable. The instructions also include code for providing the sequence of images and values for each of the plurality of parameters based on the interpolated flow paths and the interpolated time curve to a client device for rendering an image tour for display.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several aspects of the disclosed subject matter are set forth in the following figures.

FIG. 1 illustrates an example of a system configured to provide an image tour of a point of interest.

FIG. 2 illustrates an example of the database of FIG. 1 in more detail.

FIG. 3 illustrates an example of the server of FIG. 1 in more detail.

FIG. 4 illustrates an example of the client computing device of FIG. 1 in more detail.

FIG. 5 illustrates an example process by which an image tour of a point of interest may be provided.

FIG. 6 illustrates an example graph of a flow path for a relationship between a parameterization variable and an image parameter.

FIG. 7 illustrates an example graph of a time curve for a relationship between time and the parameterization variable.

FIG. 8 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is related to generating an image tour of a point of interest (e.g., the Statue of Liberty). In one implementation, a server receives (e.g., from a database) a sequence of images. Each image in the sequence has an associated depth map and each image is characterized by a plurality of parameters. Example parameters may include viewpoint position, viewpoint orientation, and field of view. The server interpolates a flow path containing points corresponding to each of the images for each of the plurality of parameters. Each flow path may relate a parameterization variable s to a parameter of the image. The flow paths may correspond to the relationship between a parameterization variable and the plurality of parameters. The server renders transitional images based on the sequence of images, the associated depth maps, and the interpolated flow paths. The server identifies slow segments and fast segments in each of the interpolated flow paths based on rendering artifacts in the transitional images. Slow segments may have less than a threshold number of pixels (e.g., 100 pixels) corresponding to rendering artifacts, while fast segments may have at least the threshold number of pixels corresponding to rendering artifacts. The server determines start and stop times for each of the slow segments. The server interpolates a time curve based on the determined start and stop times for each of the slow segments and a fixed duration of time for each of the fast segments. The time curve relates a time to the parameterization variable s. Thus, a combination of the time curve and the flow paths can be used to relate the time to the parameters of the image. The server provides the sequence of images and values for each of the plurality of parameters based on the interpolated flow paths and the interpolated time curve to a client device for rendering an image tour for display. The client device may display the image tour using, for example, a web browser application or a special purpose application.

Advantageously, in some implementations of the subject technology, an image tour that smoothly transitions between images in a sequence of images may be provided. The image tour may minimize an amount of time for which transition images containing rendering artifacts are displayed during the image tour.

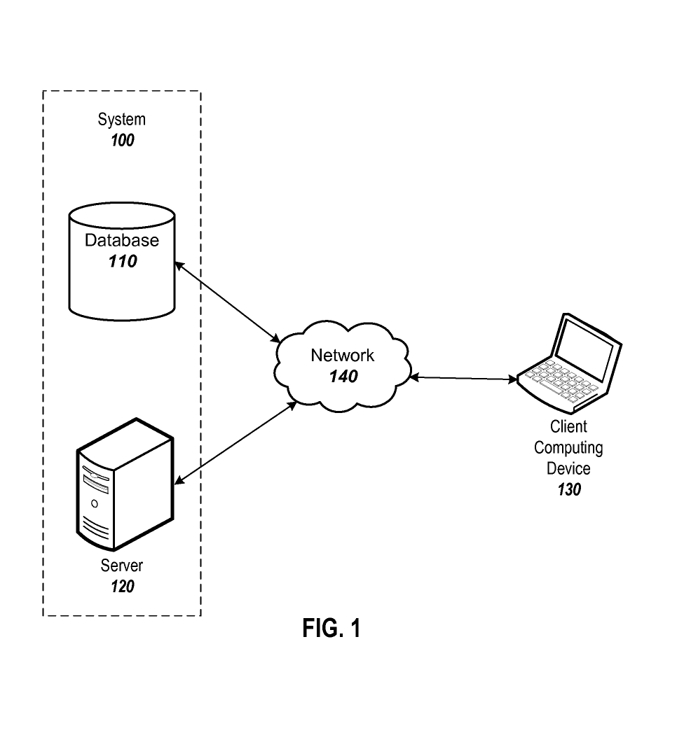

FIG. 1 illustrates an example of a system 100 configured to provide an image tour of a point of interest. As shown, the system 100 includes a database 110 and a server 120. The database 110 and the server 120 may be configured to communicate with one another or with a client computing device 130 via a network 140. The network 140 may include the Internet, an intranet, a local area network, a wide area network, a wired network, a wireless network, or a virtual private network (VPN).

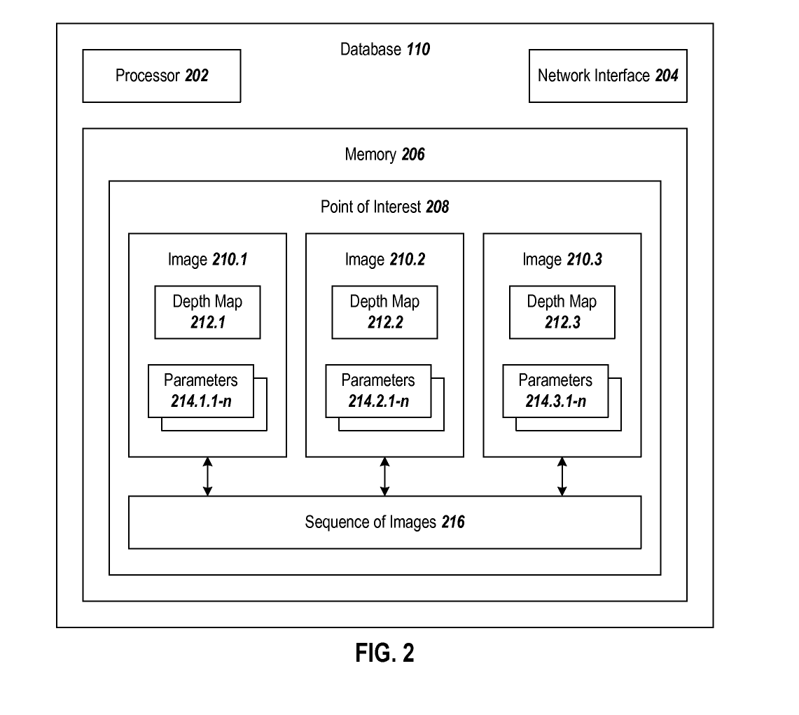

The database 110 may store data related to one or more points of interest. For example, the database may store images of each point of interest. The database may include a single machine, multiple machines, a single processor system, or a multi-processor system. One example of the database 110 is described in more detail in conjunction with FIG. 2 below.

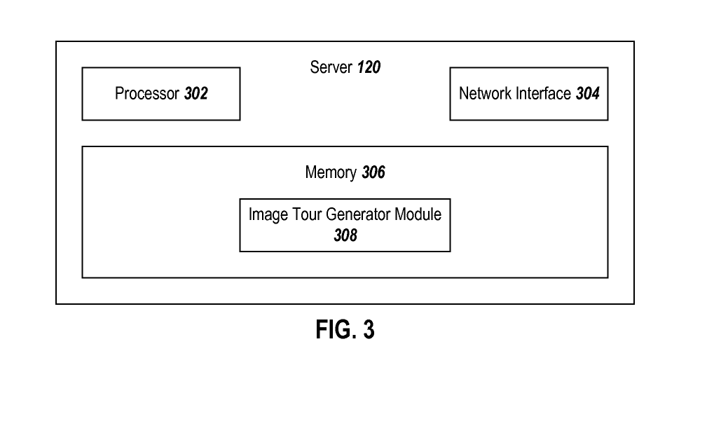

The server 120 may include a module to generate an image tour for a point of interest, images of which may be stored in the database 110 or in other machines. The server 120 may be implemented as a single machine with a single processor, a multi-processor machine, or a server farm including multiple machines with multiple processors. One example of the server 120 is described in more detail in conjunction with FIG. 3 below.

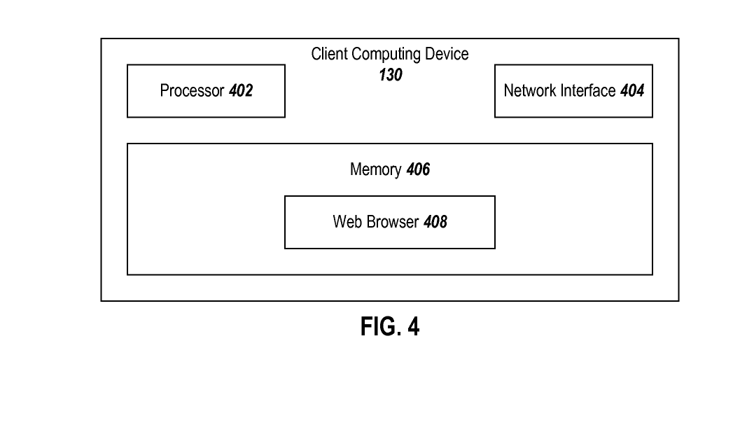

The client computing device 130 may be a laptop computer, a desktop computer, a mobile phone, a personal digital assistant (PDA), a tablet computer, a netbook, a television with one or more processors embedded therein or coupled thereto, a physical machine, or a virtual machine. The client computing device 130 may include one or more of a keyboard, a mouse, a display, or a touch screen. The client computing device 130 may also include a web browser configured to display webpages. The web browser may be configured to provide for display of an image tour, for example, by accessing a webpage for viewing the image tour. Alternatively, the client computing device 130 may include an application (e.g., a mobile phone or tablet computer application) for viewing an image tour of a point of interest. While only one client computing device 130 is illustrated in FIG. 1, the subject technology may be implemented in conjunction with one or more client computing devices 130. One example of the client computing device 130 is described in more detail in conjunction with FIG. 4 below.

FIG. 2 illustrates an example of the database 110 in more detail.

As shown, the database 110 includes a processor 202, a network interface 204, and a memory 206. The processor 202 is configured to execute computer instructions that are stored in a computer-readable medium, for example, the memory 206. The processor 202 may be a central processing unit (CPU). While only one processor 202 is illustrated, the database 110 may include multiple processors. The network interface 204 is configured to allow the database 110 to transmit and receive data in a network, e.g., network 140 of FIG. 1. The network interface 204 may include one or more network interface cards (NICs). The memory 206 may store data or instructions. As illustrated, the memory 206 includes a data structure representing a point of interest 208.

While only one data structure representing one point of interest 208 is illustrated. The subject technology may be implemented in conjunction with one or more points of interest. In one implementation, a database stores multiple data structures representing multiple points of interest (e.g., the Statue of Liberty, the White House, the Eiffel Tower, the San Francisco Museum of Modern Art, Mount Rushmore, etc.). Each point of interest may have a specified geographic location.

The data structure representing the point of interest 208 may include representations of images 210.1, 210.2, and 210.3 of the point of interest. The images 210 may be arranged in a sequence 216, e.g., representing one or more of travelling around, traversing, panning, orbiting, or zooming into or out of the point of interest. While representations of three images 210.1-3 are illustrated in FIG. 1, the subject technology may be implemented in conjunction with any number of images of the point of interest.

As shown, each image 210.k includes a depth map 212.k and one or more parameters 214.k.1-n. The depth map 212 contains information relating to the distance of the surfaces of scene objects from a viewpoint. In one implementation, the depth map 212.k provides a distance (e.g., measured in meters) from the viewpoint of the camera to the object in the image 210.k for each pixel in the image 210.k. For example, a photograph may include a tree fifty meters away from a viewpoint in front of a brick wall ninety meters away from the viewpoint. The depth map 212 may include information that the tree is fifty meters away from the viewpoint and the brick wall is ninety meters away from the viewpoint. In one implementation, a three-dimensional model of the point of interest 208 may be constructed from one or more depth maps 212 of the point of interest 208. Alternatively, a three-dimensional model for the point of interest 208 may be provided to the database 110 or the three-dimensional model may be generated based on available image(s) 210 or depth map(s) 212. In another alternative, a depth map 212.k for an image 210.k may be generated based on the three-dimensional model.

The parameters 214.k.1-n of an image 210.k may include viewpoint position, viewpoint orientation, and field of view. Each of the parameters may be parameterized with a number. For example, the viewpoint position may correspond to a coordinate in three-dimensional space, and the viewpoint orientation may correspond to a direction in which the camera is facing or a direction from the point of interest in the image to the camera. In one example, each image 210.k captures a unique view or perspective of the point of interest 208. For example, if the point of interest is the Statue of Liberty, one image may include a view of the statute from the front, one image may include a close up of the head of the statue, and one image may include a view of the statue from the right side of the statue.

The sequence 216 of images may include the images 210.1-3 arranged according to an order, e.g., first 210.1, followed by 210.2, followed by 210.3. The sequence 216 may correspond to an order in which the images 210 may be presented in an image tour of the point of interest 208 to be rendered on a client device (e.g., client computing device 130).

FIG. 3 illustrates an example of the server 120 in more detail.

As shown, the server 120 includes a processor 302, a network interface 304, and a memory 306. The processor 302 is configured to execute computer instructions that are stored in a computer-readable medium, for example, the memory 306. The processor 302 may be a central processing unit (CPU). While only one processor 302 is illustrated, the server 120 may include multiple processors. Furthermore, while the server 120 is illustrated as a single machine, the server 120 may include multiple machines, e.g., within a server farm. The network interface 304 is configured to allow the server 120 to transmit and receive data in a network, e.g., network 140 of FIG. 1. The network interface 304 may include one or more network interface cards (NICs). The memory 306 may store data or instructions. As illustrated, the memory 306 includes an image tour generator module 308. As illustrated, the image tour generator module 308 is implemented as a single module. However, the image tour generator module may also be implemented as two or more modules that work sequentially or in parallel.

The image tour generator module 308 is configured to generate an image tour of a point of interest (e.g., point of interest 208). In one implementation, the image tour generator module 308 receives a sequence of images. Each image in the sequence may have an associated depth map and be characterized by a plurality of parameters. The image tour generator module 308 also interpolates a flow path containing points corresponding to each of the images for each of the plurality of parameters. Each flow path may relate a parameterization variable to a parameter of the image. The image tour generator module 308 also identifies rendering artifacts based on the sequence of images, the associated depth maps, and the interpolated flow paths. The image tour generator module 308 also identifies slow segments and fast segments in each of the interpolated flow paths based on the identified rendering artifacts. The image tour generator module 308 also determines start and stop times for each of the slow segments. The image tour generator module 308 also interpolates a time curve based on the determined start and stop times for each of the slow segments and a fixed duration of time for each of the fast segments. The time curve may relate a time to the parameterization variable. Thus, a combination of the time curve with the flow paths may relate the time to the parameters of the image. The image tour generator module 308 also provides the sequence of images and values for each of the plurality of parameters based on the interpolated flow paths and the time curve to a client device (e.g., client computing device 130) for rendering an image tour for display.

In one implementation, the parameters include viewpoint position, viewpoint orientation, and field of view. The viewpoint position and viewpoint orientation parameters may be interpolated directly to generate a flow path for each of these parameters. However, the field of view parameter may be scaled by a scaling factor (e.g., 0.8) to provide a scaled field of view parameter. The scaled field of view parameter may be interpolated to generate a flow path. The scaling factor may be a value between 0 and 1. As a result of the use of the scaling factor, the exposure of the background pixels within the slow segments may be reduced, reducing the visibility of background pixels during the image tour. If the exposure of background pixels within the slow segments is not reduced, background pixels may become visible immediately after the viewpoint moves away from an image within the sequence of images.

FIG. 4 illustrates an example of the client computing device 130 in more detail.

As shown, the client computing device 130 includes a processor 402, a network interface 404, and a memory 406. The processor 402 is configured to execute computer instructions that are stored in a computer-readable medium, for example, the memory 406. The processor 402 may be a central processing unit (CPU). The network interface 404 is configured to allow the client computing device 130 to transmit and receive data in a network, e.g., network 140 of FIG. 1. The network interface 404 may include one or more network interface cards (NICs). The memory 406 may store data or instructions. As illustrated, the memory 406 includes a web browser 408.

The web browser 408 may be configured to display webpages via a display. The web browser 408 may be configured to display a webpage for viewing an image tour of a point of interest. Specifically, the web browser 408 may receive the sequence of images and values for each of the plurality of parameters based on the interpolated flow paths and the time curve from a server (e.g., server 120) and render the image tour for display based on the data received from the server. In some implementation, a special purpose application (e.g., a mobile phone or tablet computer application) may be used to render the image tour for display in place of the web browser 408.

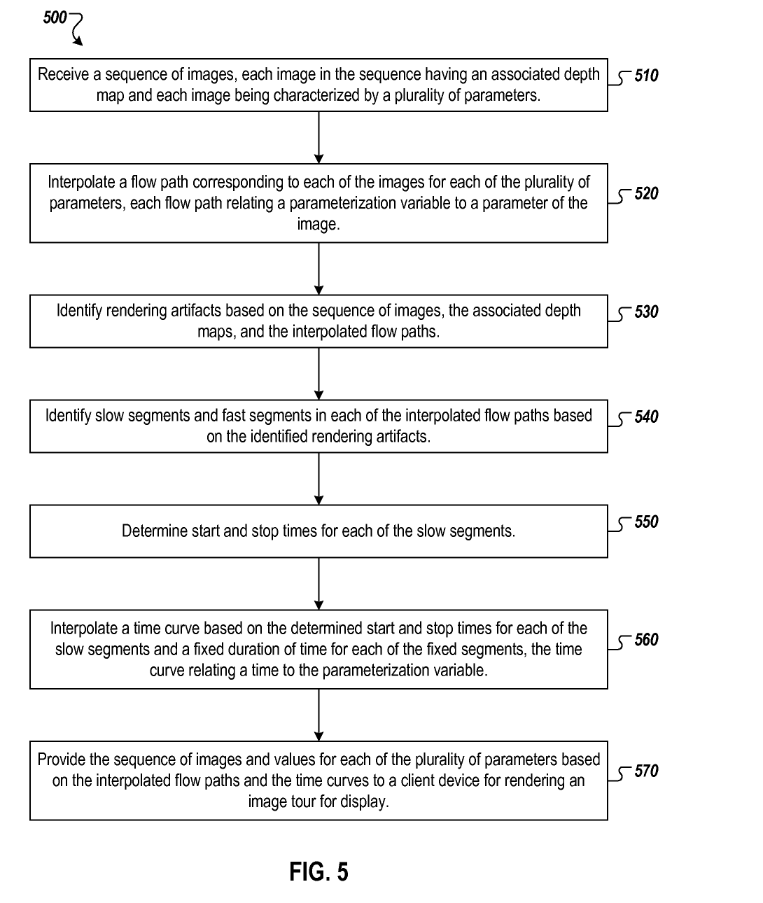

FIG. 5 illustrates an example process 500 by which an image tour of a point of interest may be provided.

The process 500 begins at step 510, where a server (e.g., server 120) receives (e.g., from a database) a sequence of images. Each image in the sequence of images has an associated depth map. Each image may be characterized by a plurality of parameters. Example parameters include viewpoint position, viewpoint orientation, and field of view. The images in the sequence may be associated with a point of interest (e.g., the White House).

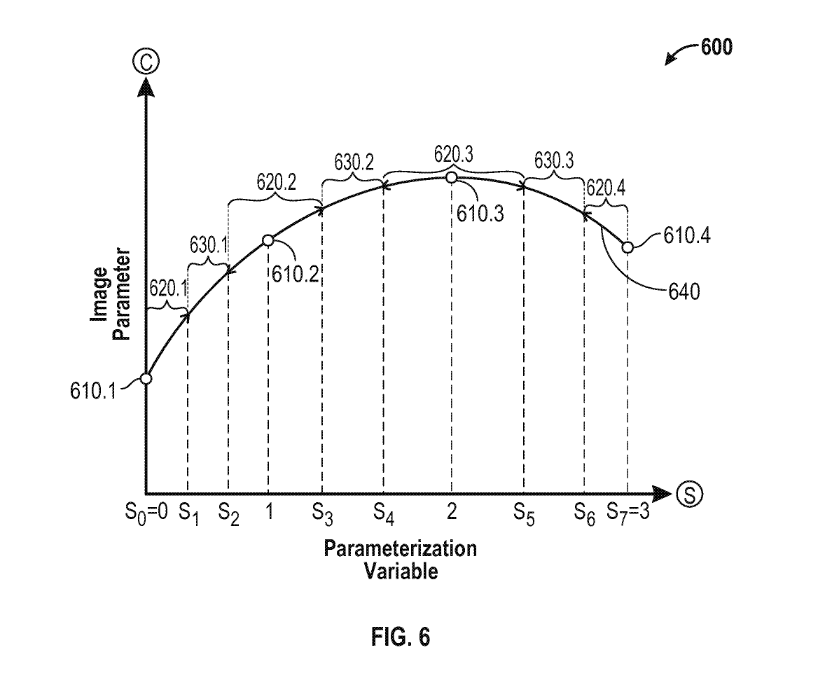

In step 520, the server interpolates a flow path corresponding to the sequence of images for each of the plurality of parameters. Each flow path relates a parameterization variable to a parameter of the image. The parameterization variable may correspond to images in the sequence of image (e.g., the first image in the sequence may correspond to parameterization variable s=0, the second image in the sequence may correspond to parameterization variable s=1, etc.). The flow paths may be interpolated using a spline interpolation curve, for example, a piecewise cubic hermite interpolating polynomial (PCHIP). A spline interpolation curve or PCHIP flow path may be advantageous because PCHIP functions guarantee monotonicity between the sample points and prevent overshooting or oscillation. As used herein, the term “monotonicity” encompasses its plain and ordinary meaning, including but not limited to a function ƒ, where, if x₂ exceeds x₁, then ƒ(x₂) exceeds ƒ(x₁). An example of a flow path (flow path 640) is illustrated in FIG. 6, and described in greater detail below. The server may generate a separate flow path for each parameter, e.g., one flow path for viewpoint position, one for viewpoint orientation, and one for field of view. A translation flow path may contain the viewpoint positions of the images in an image tour of the point of interest. A rotation flow path may contain the viewpoint orientations of the images in the image tour. A field of view flow path may contain the fields of view of the images in the image tour.

In step 530, the server identifies rendering artifacts based on the sequence of images, the associated depth maps, and the interpolated flow paths.

In one example, the server may identify the rendering artifacts by rendering transitional images based on the sequence of images, the associated depth maps, and the interpolated flow paths and identifying rendering artifacts in the transitional images. The transitional images are rendered using the flow paths to determine the parameters (e.g., viewpoint position, viewpoint orientation, or field of view) for the image. Image data of images in the sequence of images, and the underlying three-dimensional data (e.g., depth maps) may be used to depict the point of interest from the viewpoint position, viewpoint orientation, and field of view defined by the parameters. In some of the transitional images, artifacts may be created when there is insufficient data in the image data or depth maps to accurately render the point of interest from the position, orientation, and field of view at given points on the flow paths associated with the transitional images. Two rendered transitional images, one of which may be based on a first image within the sequence and another of which is based on a second image within the sequence, may be blended as the tour moves from one image in the sequence to the next. The blending may occur during a fast segment of the tour (as described in conjunction with step 540 below). In the image tour, the transitional images may be displayed to transition between consecutive images within the sequence of images.

In another example, the server may identify rendering artifacts using projections of a depth map associated with an image on camera positions based on the flow paths for the set of parameters. More specifically, the server increments the parameterization variable (s) along each of the flow paths to identify incremental camera positions corresponding to transitional images between images in the sequence of images. Different incremental values may be used. For example, segments of the flow paths between images in the sequence of images may be incremented into 30 increments or 100 increments. Each increment of the parameterization variable (s) along the flow path is associated with image parameter (e.g., viewpoint position, viewpoint orientation, and field of view) values for a transitional image. The server projects, for each incremental camera position, a mesh model based on the depth map associated with the image onto the incremental camera position. The server identifies the rendering artifacts using the projections. For example, the server may analyze spacing of the projected points to identify rendering artifacts.

The rendering artifacts may include triangle stretching, which occurs when rendering images with insufficient depth map information. The server may analyze points in the projection for triangle stretching rendering artifacts by determining that the spacing between some points in the projection are spaced beyond a stretching factor threshold. The server may determine that these points correspond to a triangle stretching rendering artifact. For example, the depth map may be associated with an image where a wall of a building is viewed from a viewing angle perpendicular to the wall. However, the camera position may correspond to a view of the wall at an angle of eighty-five degrees from a line perpendicular to the wall. As a result, stretching rendering artifacts may occur on the portion of the projection corresponding to the wall.

The rendering artifacts may include ghosting. The server may identify the ghosting rendering artifacts by determining that the projection of the depth map includes some points for which the geometry is uncertain or cannot be determined. As used herein, the term “geometry” encompasses its plain and ordinary meaning including but not limited to shape or other projection or image data for points in a projection or an image. Ghosting may occur when the depth map does not include some data that is required to generate the projection. For example, the depth map may be associated with an image of a building with a tree in front of the building, while the camera position may correspond to a view of the building from position between the tree and the building. As a result, the depth map may lack data for points on the building that were covered by the tree in the image and ghosting artifacts may occur on the portion of the projection corresponding to those points.

In step 540, the server identifies slow segments and fast segments in each of the interpolated flow paths based on the identified rendering artifacts. The rendering artifacts, may include, for example, triangle stretching and background artifacts. Background artifacts occur when the viewpoint position of the images becomes far away (e.g., more than 100 meters away or more than 50% closer to or further from the point of interest than the viewpoint position of initial image) from the viewpoint position of the initial image in the sequence of images. Slow segments may correspond to images in the sequence and to transitional images that include less than a threshold number of pixels (e.g., 100 pixels or 0.03% of the pixels in the image) corresponding to rendering artifacts or triangles used to render the images being stretched by less than a certain amount (e.g., stretched by less than 50%). Fast segments may include rendered images with at least the threshold number of pixels with the rendering artifacts or triangles used to render the images being stretched by more than the certain amount. The threshold number may correspond to a preset proportion (e.g., 0.03% or 3/10,000) of pixels in the image. The certain amount may correspond to a preset number of pixels (e.g. 50 pixels) or a preset proportion (e.g. 50%) of the pixels in the triangle or in a side length or height of the triangle. As a result, images with a larger number of rendering artifacts are displayed more quickly in the image tour than images with a smaller number of rendering artifacts, and the rendering artifacts contribute less to reducing the overall quality of the image tour.

In step 550, the server determines start and stop times for each of the slow segments. The server may assign a specified amount of time (e.g., 0.7 seconds) to each of the fast segments. The server may determine an amount of time for each of the slow segments so that the optical flow motion is roughly constant (e.g., either is exactly constant or varies between a minimum value and a maximum value, such that the maximum value is, at most, 10% greater than the minimum value) throughout the tour. The optical flow motion for each of the fast segments may be determined based on the specified amount of time for each of the fast segments. The optical flow motion for each of the slow segments may be calculated based on the optical flow motion for each of the fast segments (e.g., the optical flow motion for the slow segments may be equal to that of the fast segments or a preset factor slower (e.g., half as fast) than the optical flow motion of the fast segments). The amount of time for each slow segment may then be determined based on the optical flow motion of the slow segment and the image data in the slow segment. The start and stop times for each of the slow segments may be determined based on the specified amount of time assigned to the fast segments and the amount of time determined for the slow segments.

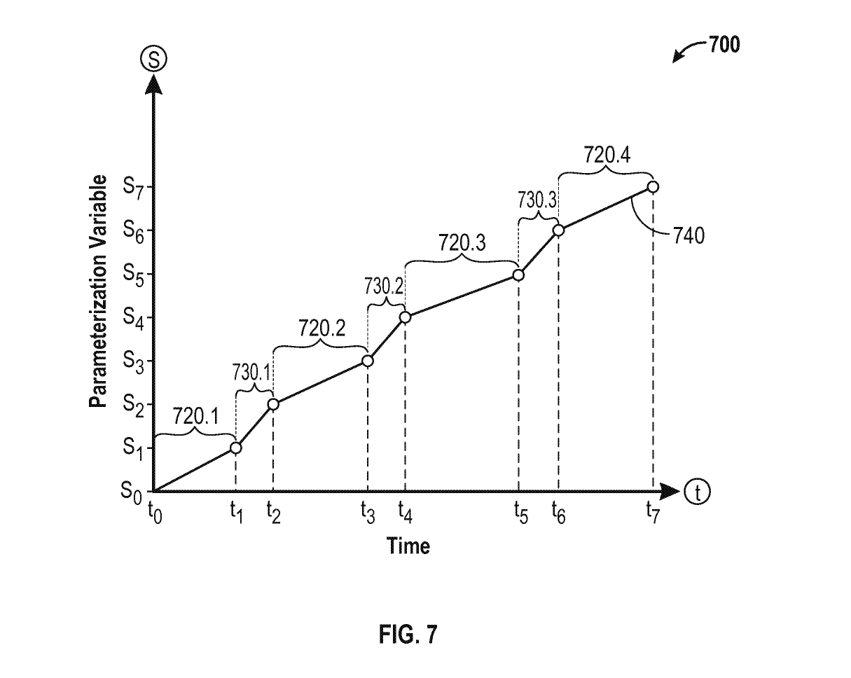

In step 560, the server interpolates a time curve based on the determined start and stop times for each of the slow segments and a fixed duration of time for each of the fast segments. The time curve relates a time to the parameterization variable. Thus, a combination of the time curve and the flow paths can be used to relate the time to the parameters of the image. The time curve may be interpolated using a spline interpolation curve. An example of a time curve (time curve 740) is illustrated in FIG. 7, and described in greater detail below.

The server may determine a viewpoint movement for the image tour based on a combination of the time curve with the flow path. As illustrated in FIG. 7, the time curve 740 provides a correspondence of the time t to the parameterization variable s. As illustrated in FIG. 6, the flow path 640 provides a correspondence of the parameterization variable s to the image parameter c. Thus, combining the time curve with the flow path may provide a correspondence of the time t to the image parameter c.

In step 570, the server provides the sequence of images and values for each of the plurality of parameters based on the interpolated flow paths and the time curve to a client device (e.g., client computing device 130) for rendering an image tour for display. The client device may render the image tour for display, for example, via a web browser application, a mobile phone application, or a tablet computer application. After step 570, the process 500 ends.

FIG. 6 illustrates an example graph 600 of a flow path 640 for a relationship between a parameterization variable s and an image parameter c.

The graph 600 plots an image parameter c on the vertical axis versus a parameterization variable s on the horizontal axis. The image parameter c may correspond to any of the parameters 214 described in conjunction with FIG. 2. Specifically, the image parameter c may include viewpoint position, viewpoint orientation, and field of view. In one example, the server may generate multiple relationships, as plotted in graph 600—one for each of the image parameters: viewpoint position, viewpoint orientation, and field of view. Each of the image parameters may be parameterized according to the same parameterization variable s. The graph 600 includes points 610.1, 610.2, 610.3, and 610.4 that correspond to images of a point of interest in the sequence of images (e.g., images 210 of FIG. 2) in one example implementation. As illustrated, each of the images is associated with an integer value of the parameterization variable s, where s is equal to one of 0, 1, 2, or 3. While four points 610.1-4 are illustrated here, the subject technology may be implemented with any number of images and, thus, any number of points 610 corresponding to the images.

The points 610 are on a flow path 640. Other points (not points 610) on the flow path 640 may be used to render the transitional images. A transitional image may be rendered based on parameters corresponding to a specified point on the flow path not corresponding to any image in the sequence of images. The flow path 640 illustrates an example of the relationship between the image parameter c and the parameterization variable s. The flow path 640 may be a spline interpolation curve, for example, a piecewise cubic hermite interpolating polynomial (PCHIP). The flow path 640 includes regions 620.1-4 near the points 610.1-4 and regions 630.1-3 between the regions 620.1-4 not near the points 610.1-4. The regions 620 may correspond to the slow segments of the image tour, which may be identified, for example, the process 500 of FIG. 5 in step 540. The regions 630 may correspond to the fast segments of the image tour, which may also be identified, for example, by the process 500 of FIG. 5 in step 540.

FIG. 7 illustrates an example graph 700 of a time curve for a relationship between time t and the parameterization variable s.

The graph 700 plots a time t on the horizontal axis versus the parameterization variable s on the vertical axis. The parameterization variable s also corresponds to the horizontal axis of FIG. 6. As shown, a time curve 740 illustrates the relationship between the time t and the parameterization variable s. The curve 740 includes regions 720 corresponding to the slow segments and regions 730 corresponding to the fast segment. As shown, each region 730.1-3 corresponding to the fast segments has the same constant length in time or temporal length (e.g., 0.7 seconds), while the regions 720.1-4 corresponding to the slow segments have different temporal lengths. The temporal lengths of the regions 720.1-4 corresponding to the slow segments may be determined based on the temporal length of the regions 730.1-3 corresponding to the fast segments so that the optical flow motion is roughly constant (e.g., varies between a minimum value and a maximum value, such that the maximum value is, at most, 10% greater than the minimum value) throughout the tour.

In both FIG. 6 and FIG. 7, the regions 620 and 720 corresponding to the slow segments are between s₀=0 and s₁, between s₂ and s₃, between s₄ and s₅, and between s₆ and s₇=3. The regions 630 and 720 corresponding to the fast segments are between s₁ and s₂, between s₃ and s₄, and between s₅ and s₆. The values s₀₋₇ correspond to numeric values of the parameterization variable s.

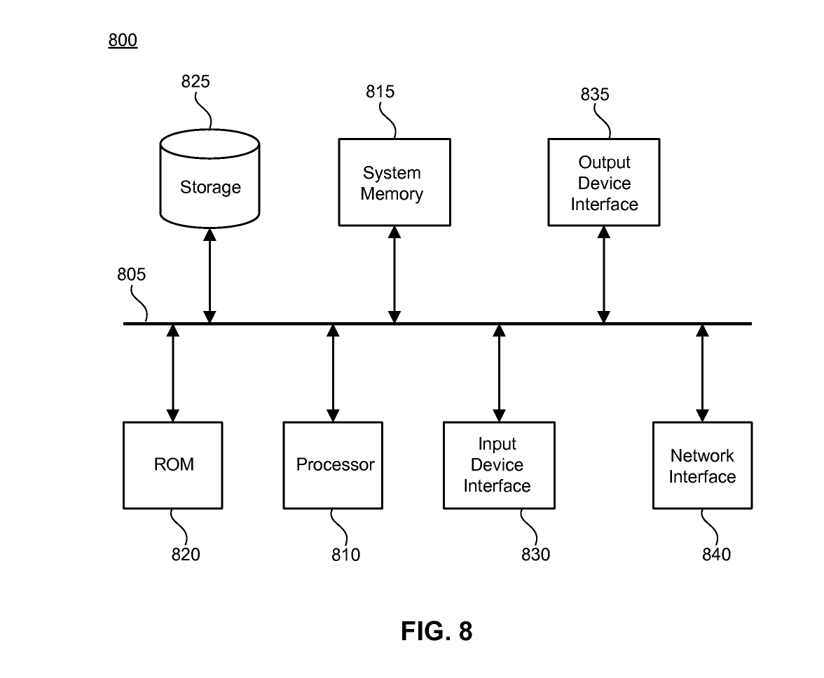

FIG. 8 conceptually illustrates an electronic system 800 with which some implementations of the subject technology are implemented. For example, one or more of the database 110, the server 120, or the client computing device 130 may be implemented using the arrangement of the electronic system 800. The electronic system 800 can be a computer (e.g., a mobile phone, PDA), or any other sort of electronic device. Such an electronic system includes various types of computer readable media and interfaces for various other types of computer readable media. Electronic system 800 includes a bus 805, processing unit(s) 810, a system memory 815, a read-only memory 820, a permanent storage device 825, an input device interface 830, an output device interface 835, and a network interface 840.

The bus 805 collectively represents all system, peripheral, and chipset buses that communicatively connect the numerous internal devices of the electronic system 800. For instance, the bus 805 communicatively connects the processing unit(s) 810 with the read-only memory 820, the system memory 815, and the permanent storage device 825.

From these various memory units, the processing unit(s) 810 retrieves instructions to execute and data to process in order to execute the processes of the subject technology. The processing unit(s) can be a single processor or a multi-core processor in different implementations.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some implementations of the subject technology use a mass-storage device (for example a magnetic or optical disk and its corresponding disk drive) as the permanent storage device 825.

Other implementations use a removable storage device (for example a floppy disk, flash drive, and its corresponding disk drive) as the permanent storage device 825. Like the permanent storage device 825, the system memory 815 is a read-and-write memory device. However, unlike storage device 825, the system memory 815 is a volatile read-and-write memory, such a random access memory. The system memory 815 stores some of the instructions and data that the processor needs at runtime. In some implementations, the processes of the subject technology are stored in the system memory 815, the permanent storage device 825, or the read-only memory 820. For example, the various memory units include instructions for providing an image tour of a point of interest in accordance with some implementations. From these various memory units, the processing unit(s) 810 retrieves instructions to execute and data to process in order to execute the processes of some implementations.

The bus 805 also connects to the input and output device interfaces 830 and 835. The input device interface 830 enables the user to communicate information and select commands to the electronic system. Input devices used with input device interface 830 include, for example, alphanumeric keyboards and pointing devices (also called “cursor control devices”). Output device interfaces 835 enables, for example, the display of images generated by the electronic system 800. Output devices used with output device interface 835 include, for example, printers and display devices, for example cathode ray tubes (CRT) or liquid crystal displays (LCD). Some implementations include devices for example a touchscreen that functions as both input and output devices.

Finally, as shown in FIG. 8, bus 805 also couples electronic system 800 to a network (not shown) through a network interface 840. In this manner, the electronic system 800 can be a part of a network of computers (for example a local area network (“LAN”), a wide area network (“WAN”), or an Intranet, or a network of networks, for example the Internet. Any or all components of electronic system 800 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method for generating an image tour, the method comprising:
receiving a sequence of images, each image in the sequence having an associated depth map and each image being characterized by a plurality of parameters, the plurality of parameters comprising a field of view parameter;
interpolating a flow path containing points corresponding to each of the images for each of the plurality of parameters, each flow path relating a parameterization variable to a parameter of the image, wherein interpolating a flow path for each of the plurality of parameters comprises, for each image, scaling a respective field of view associated with the image by a scaling factor between 0 and 1, the scaling factor remaining constant from image-to-image, and interpolating a flow path based on the scaled fields of view, the interpolated flow path including one or more interpolated fields of view generated according to the scaled fields of view;
identifying rendering artifacts based on the sequence of images, the associated depth maps, and the interpolated flow paths;
identifying slow segments and fast segments of the sequence of images to include in each of the interpolated flow paths based on the identified rendering artifacts, wherein identifying the slow and fast segments includes:
identifying slow segments including transitional images having less than a threshold number of pixels corresponding to the identified rendering artifacts; and
identifying fast segments including transitional images having at least the threshold number of pixels corresponding to the identified rendering artifacts;
determining start and stop times for each of the slow segments;
interpolating a time curve based on the determined start and stop times for each of the slow segments and a fixed duration of time for each of the fast segments, the time curve relating a time to the parameterization variable; and
providing the sequence of images and values for each of the plurality of parameters based on the interpolated flow paths and the interpolated time curve to a client device for rendering an image tour for display.

2. The method of claim 1, wherein identifying the rendering artifacts comprises:
rendering transitional images based on the sequence of images, the associated depth maps, and the interpolated flow paths; and
identifying rendering artifacts in the transitional images.

3. The method of claim 1, wherein identifying the rendering artifacts comprises:
incrementing the parameterization variable along the flow paths;
calculating, for each increment of the parameterization variable, a value for each of the plurality of parameters based on the interpolated flow path;
determining, for each increment of the parameterization variable, a projection of the associated depth map for an image in the sequence of images; and
identifying the rendering artifacts based on the projection.

4. The method of claim 1, wherein the plurality of parameters further comprises viewpoint position and viewpoint orientation.

5. The method of claim 1, wherein the flow paths are interpolated using a spline interpolation curve.

6. The method of claim 5, wherein the spline interpolation curve comprises a piecewise cubic hermite interpolating polynomial (PCHIP) curve.

7. The method of claim 1, wherein the time curve is interpolated using a spline interpolation curve.

8. The method of claim 1, wherein at least one transitional image is rendered based on a value of the parameter corresponding to a specified point on the flow path, the specified point on the flow path not corresponding to any image in the sequence of images.

9. The method of claim 1, wherein each image in the sequence of images is associated with a point of interest having a specified geographic location.

10. The method of claim 1, wherein the slow segments in the image tour are characterized by a constant optical flow.

11. (canceled)

12. The method of claim 1, wherein the threshold number of pixels corresponds to a preset proportion of pixels in each transitional image.

13. A non-transitory computer-readable medium for generating an image tour, the computer-readable medium comprising instructions which, when executed by one or more computers, cause the one or more computers to:
interpolate a flow path for each of a plurality of parameters, the plurality of parameters comprising a field of view parameter, and the flow path containing points corresponding to each image in a sequence of images, wherein each image in the sequence has an associated depth map and each image is characterized by the plurality of parameters, wherein each flow path relates a parameterization variable to a parameter of the image, and wherein to interpolate a flow path for each of the plurality of parameters comprises, for each image, scaling a respective field of view associated with the image by a scaling factor between 0 and 1, the scaling factor remaining constant from image-to-image, and interpolating a flow path based on the scaled fields of view, the interpolated flow path including one or more interpolated fields of view generated according to the scaled fields of view;
identify rendering artifacts based on the sequence of images, the associated depth maps, and the interpolated flow paths;
identify slow segments and fast segments of the sequence of images to include in each of the interpolated flow paths based on the identified rendering artifacts, wherein identifying the slow and fast segments includes:
identifying slow segments including transitional images having less than a threshold number of pixels corresponding to the identified rendering artifacts; and
identifying fast segments including transitional images having at least the threshold number of pixels corresponding to the identified rendering artifacts;
determine start and stop times for each of the slow segments;
interpolating a time curve based on the determined start and stop times for each of the slow segments and a fixed duration of time for each of the fast segments, the time curve relating a time to the parameterization variable; and
provide the sequence of images and values for each of the plurality of parameters based on the interpolated flow paths and the interpolated time curve to a client device for rendering an image tour for display.

14. The computer-readable medium of claim 13, wherein the plurality of parameters further comprises viewpoint position and viewpoint orientation.

15. The computer-readable medium of claim 13, wherein the flow paths are interpolated using a spline interpolation curve.

16. The computer-readable medium of claim 15, wherein the spline interpolation curve comprises a piecewise cubic hermite interpolating polynomial (PCHIP) curve.

17. The computer-readable medium of claim 13, wherein the time curve is interpolated using a spline interpolation curve.

18. The computer-readable medium of claim 13, wherein at least one transitional image is rendered based on a value of the parameter corresponding to a specified point on the flow path, the specified point on the flow path not corresponding to any image in the sequence of images.

19. The computer-readable medium of claim 13, wherein each image in the sequence of images is associated with a point of interest having a specified geographic location.

20. The computer-readable medium of claim 13, wherein the slow segments in the image tour are characterized by a constant optical flow.

21. (canceled)

22. The computer-readable medium of claim 13, wherein the threshold number of pixels corresponds to a preset proportion of pixels in each transitional image.

23. A system for generating an image tour, the system comprising:
one or more processors; and
a memory comprising:
a data structure representing a sequence of images, each image being characterized by a plurality of parameters the plurality of parameters comprising a field of view parameter; and
instructions which, when executed by the one or more processors, cause the one or more processors to:
interpolate a flow path containing points corresponding to each of the images for each of the plurality of parameters, each flow path relating a parameterization variable to a parameter of the image, and wherein to interpolate a flow path for each of the plurality of parameters comprises, for each image, scaling a respective field of view associated with the image by a scaling factor between 0 and 1, the scaling factor remaining constant from image-to-image, and interpolating a flow path based on the scaled fields of view, the interpolated flow path including one or more interpolated fields of view generated according to the scaled fields of view;
identify rendering artifacts based on the sequence of images, and the interpolated flow paths;
identify slow segments and fast segments of the sequence of images to include in each of the interpolated flow paths based on the identified rendering artifacts, wherein to identify the slow and fast segments includes:
identifying slow segments including transitional images having less than a threshold number of pixels corresponding to the identified rendering artifacts; and
identifying fast segments including transitional images having at least the threshold number of pixels corresponding to the identified rendering artifacts;
determine start and stop times for each of the slow segments;
interpolate a time curve based on the determined start and stop times for each of the slow segments and a fixed duration of time for each of the fast segments, the time curve relating a time to the parameterization variable; and
provide the sequence of images and values for each of the plurality of parameters based on the interpolated flow paths and the interpolated time curve to a client device for rendering an image tour for display.
